(19) United States
(12) Patent Application Publication
(10) Pub. No.: US 2026/0283900 A1
(43) Pub. Date: Sep. 24, 2026

(54) RECIPROCATING MASSAGE DEVICE

(71) Applicant: SHENZHEN S-HANDE TECHNOLOGY CO., LTD., Shenzhen City (CN)

(72) Inventors: Jing He, Shenzhen City (CN); Siyang Chen, Shenzhen City (CN)

(73) Assignee: SHENZHEN S-HANDE TECHNOLOGY CO., LTD., Shenzhen City (CN)

(21) Appl. No.: 19/373,379

(22) Filed: Oct. 29, 2025

(30) Foreign Application Priority Data
Mar. 24, 2025 (CN) 202510349829.0

(51) Int. Cl. A61H 23/02

(52) U.S. Cl. CPC A61H 23/0254; A61H 2201/0165; A61H 2201/14; A61H 2201/1669

(57) ABSTRACT

Provided in the present disclosure is a reciprocating massage device, relating to the technical field of physiotherapy massage. The reciprocating massage device includes: a machine shell, a driving member, an elastic frame and a massage head. The driving member and the elastic frame are respectively mounted on the machine shell, the driving member is in transmission connection with the elastic frame, and drives the movable part of the elastic frame to move reciprocally; the massage head is in transmission connection with the movable part. Vibration massage is realized through the reciprocating movement of the massage head.

### CROSS-REFERENCE TO RELATED APPLICATIONS

The present disclosure claims the priority to the Chinese Patent Application No. 2025103498290, filed with the Chinese Patent Office on March 24, 2025, and entitled “RECIPROCATING MASSAGE DEVICE”, the contents of which are incorporated herein by reference in entirety.

### TECHNICAL FIELD

The present disclosure relates to the technical field of physiotherapy massage, and in particular to a reciprocating massage device.

### BACKGROUND ART

Human body massagers, as a common type of health-care equipment, are widely used in the fields of home and personal care. With the improvement of people’s health awareness and the growing pursuit of quality of life, a wide variety of massagers with different functions are available on the market. Among them, massagers that use mechanical vibration as the main working method account for a relatively large share of the market. Such massagers apply periodic force to specific parts of the human body to achieve effects such as promoting blood circulation, relieving muscle tension and fatigue.

Traditional human body massagers usually adopt an electric motor to drive an eccentric wheel or other similar mechanisms to realize the vibration effect, thereby causing the skin and muscles of the massaged part to tremor. The key of this massage method lies in adjusting the vibration amplitude and frequency parameters to change the massage experience of the user. Specifically, a smaller amplitude combined with a lower frequency can usually only provide mild stimulation, and the effect on deep muscle relaxation is limited. When the amplitude is increased and the frequency is raised, the massage sensation can be significantly enhanced, making the massage stimulation more in-depth. However, it is found in practical application that although an excessively high vibration intensity can bring a strong massage sensation in a short period, it is also easy to cause discomfort or even numbness in the massaged area, thereby affecting the overall comfort and safety of the massage.

### SUMMARY

The objective of the present disclosure is to provide a reciprocating massage device, so as to solve the technical problem in the prior art that massage devices tend to cause numbness and discomfort in the massaged parts.

In a first aspect, a reciprocating massage device is provided in the present disclosure, including: a machine shell, a driving member, an elastic frame and a massage head; the driving member and the elastic frame are respectively mounted on the machine shell, the driving member is in transmission connection with the elastic frame, and drives the movable part of the elastic frame to move reciprocally; the massage head is in transmission connection with the movable part.

In an optional embodiment, the movable part has a degree of freedom to move reciprocally along the x-direction; and the elastic frame and the massage head are arranged along the z-direction, wherein the x-direction is perpendicular to the z-direction.

In an optional embodiment, one end of the movable part is connected to a first elastic support part, and the other end thereof is connected to a second elastic support part, wherein the x-direction points from the first elastic support part to the second elastic support part; and the first elastic support part and the second elastic support part are respectively connected to the machine shell.

In an optional embodiment, the first elastic support part includes: a first longitudinal arm, a first bending part and a first spring arm; the first longitudinal arm and the first spring arm are spaced apart and respectively extend along the z-direction. The top end of the first longitudinal arm is connected to the movable part, and the bottom end of the first longitudinal arm is connected to the bottom end of the first spring arm through the first bending part. The second elastic support part includes: a second longitudinal arm, a second bending part and a second spring arm; the second longitudinal arm and the second spring arm are spaced apart and respectively extend along the z-direction; the top end of the second longitudinal arm is connected to the movable part, and the bottom end of the second longitudinal arm is connected to the bottom end of the second spring arm through the second bending part. The top end of the first spring arm and the top end of the second spring arm are respectively connected to the machine shell.

In an optional embodiment, the first elastic support part and the second elastic support part are respectively formed by bending sheet-like structures; the thickness dimension of the first spring arm is smaller than the thickness dimension of the first longitudinal arm, and the thickness dimension of the second spring arm is smaller than the thickness dimension of the second longitudinal arm.

In an optional embodiment, the movable part, the first elastic support part and the second elastic support part are configured as an integrated structure.

In an optional embodiment, the driving member include: a motor and an eccentric wheel, wherein the eccentric wheel is in transmission connection with the motor. An eccentric shaft is connected to the eccentric wheel, and the axis of the eccentric shaft is spaced apart from and parallel to the axis of the eccentric wheel; the eccentric shaft is in transmission connection with the movable part.

In an optional embodiment, the driving member further include a connecting rod, wherein one end of the connecting rod is hinged to the eccentric wheel through the eccentric shaft, and the other end of the connecting rod is hinged to the movable part.

In an optional embodiment, the movable part is connected with a shock-absorbing member, and the eccentric wheel is in transmission connection with the shock-absorbing member to drive the movable part.

In an optional embodiment, the movable part is provided with a groove, and the shock-absorbing member is inserted into the groove.

In an optional embodiment, the shock-absorbing member is provided with a sliding slot extending along the y-direction, and the eccentric shaft extends along the z-direction, wherein the y-direction is perpendicular to the z-direction; the eccentric shaft is slidably fitted in the sliding slot.

In an optional embodiment, the movable part is connected with a support part, and the support part is inserted into the massage head.

In an optional embodiment, the massage head includes a soft rubber head, and the soft rubber head is in transmission connection with the movable part.

In an optional embodiment, the massage head further includes a mounting frame, the soft rubber head is connected with the mounting frame, and the mounting frame is detachably connected with the machine shell.

In an optional embodiment, the machine shell includes: an inner shell and a soft rubber outer shell; the driving member and the elastic frame are respectively mounted inside the inner shell, and the soft rubber outer shell is sleeved over the outer side of the inner shell.

In an optional embodiment, the massage head is connected with the inner shell, and a slot is formed between the massage head and the inner shell; one of the massage head and the inner shell is provided with a protruding part protruding into the slot, and the other is provided with a limiting slot which is communicated with the slot and recessed away from the slot. The soft rubber outer shell is provided with a flange part inserted into the slot, and the flange part is provided with a notch matching the protruding part and a limiting protrusion inserted into the limiting slot.

The embodiment of the present disclosure brings the following beneficial effects. The driving member and the elastic frame are respectively mounted on the machine shell, the driving member is in transmission connection with the elastic frame, the movable part of the elastic frame can move reciprocally, and the massage head is in transmission connection with the movable part. Therefore, vibration massage can be realized through the reciprocal movement of the massage head. The elastic frame can limit mechanical movement and realize shock absorption at the reciprocating limit positions of mechanical vibration, and the action range of vibration massage is larger, which is beneficial to alleviating numbness during massage and improving massage comfort.

To make the above objectives, features, and advantages of the present disclosure more obvious and understandable, preferred embodiments are specifically cited below and described in detail in conjunction with the drawings.

### BRIEF DESCRIPTION OF THE DRAWINGS

To more clearly illustrate the technical solutions in the specific embodiments of the present disclosure or related technologies, the drawings required in the description of the specific embodiments or related technologies are briefly introduced below. Obviously, the drawings in the following description are some embodiments of the present disclosure. For those of ordinary skill in the art, other drawings can also be obtained according to these drawings without making inventive efforts.

FIG. 1 is a sectional view of a reciprocating massage device provided in the embodiment of the present disclosure.

FIG. 2 is a schematic diagram of an inner shell, a driving member, an elastic frame and a massage head of the reciprocating massage device provided in the embodiment of the present disclosure.

FIG. 3 is a schematic diagram of a driving member of the reciprocating massage device provided in the embodiment of the present disclosure.

FIG. 4 is a schematic diagram of an elastic frame of the reciprocating massage device provided in the embodiment of the present disclosure.

FIG. 5 is a schematic diagram of an inner shell, a driving member, an elastic frame, a massage head and a shock-absorbing member of the reciprocating massage device provided in the embodiment of the present disclosure.

FIG. 6 is a schematic diagram of an elastic frame and a shock-absorbing member of the reciprocating massage device provided in the embodiment of the present disclosure.

FIG. 7 is a schematic diagram of a soft rubber head moving to a limit position in the reciprocating massage device provided in the embodiment of the present disclosure.

FIG. 8 is a schematic diagram a soft rubber head moving to another limit position in the reciprocating massage device provided in the embodiment of the present disclosure.

FIG. 9 is an enlarged schematic diagram of position A in FIG. 1.

FIG. 10 is a schematic diagram of an inner shell of the reciprocating massage device provided in the embodiment of the present disclosure.

FIG. 11 is a schematic diagram of a soft rubber outer shell of the reciprocating massage device provided in the embodiment of the present disclosure.

Reference numbers: 100 - machine shell; 110 - inner shell; 111 - limiting slot; 112 - embedded slot; 120 - soft rubber outer shell; 121 - flange part; 122 - notch; 123 - limiting protrusion; 124 - soft rubber protrusion; 200 - driving member; 210 - motor; 220 - eccentric wheel; 221 - eccentric shaft; 230 - connecting rod; 300 - elastic frame; 301 - movable part; 302 - first elastic support part; 303 - second elastic support part; 304 - support part; 305 - shaft part; 311 - groove; 321 - first longitudinal arm; 322 - first bending part; 323 - first spring arm; 331 - second longitudinal arm; 332 - second bending part; 333 - second spring arm; 400 - massage head; 401 - protruding part; 410 - mounting frame; 420 - soft rubber head; 430 - cover body; 500 - shock-absorbing member; 501 - sliding slot; 600 - slot.

### DETAILED DESCRIPTION OF EMBODIMENTS

The technical solutions of the present disclosure will be clearly and completely described below in conjunction with the drawings. Obviously, the described examples are some examples of the present disclosure, rather than all the examples. Based on the examples in the present disclosure, all other examples obtained by those of ordinary skill in the art without making inventive efforts shall fall within the protection scope of the present disclosure.

In the description of the present disclosure, it should be noted that the orientations or positional relationships indicated by the terms “center”, “upper”, “lower”, “left”, “right”, “vertical”, “horizontal”, “inner” and “outer” are based on the orientations or positional relationships shown in the drawings, which are only for the convenience of describing the present disclosure and simplifying the description, rather than indicating or implying that the referred device or element must have a specific orientation, be constructed and operated in a specific orientation, and thus shall not be construed as limiting the present disclosure. In addition, the terms “first”, “second”, and “third” are only used to distinguish names, and shall not be construed as indicating or implying relative importance. For the physical quantities in the formulas, if there is no specified annotation, should be understood as base quantities of the International System of Units base units, or as derived quantities obtained from base quantities through mathematical operations such as multiplication, division, differentiation, or integration.

In the description of the present disclosure, it should be noted that unless otherwise clearly specified and limited, the terms “mount”, “connect with” and “connection” shall be understood in a broad sense. For example, it can be a fixed connection, a detachable connection, or an integral connection; it can be a mechanical connection or an electrical connection; it can be a direct connection, or an indirect connection through an intermediate medium, or internal communication between two elements. For those of ordinary skill in the art, the specific meanings of the above terms in the present disclosure can be understood according to specific situations.

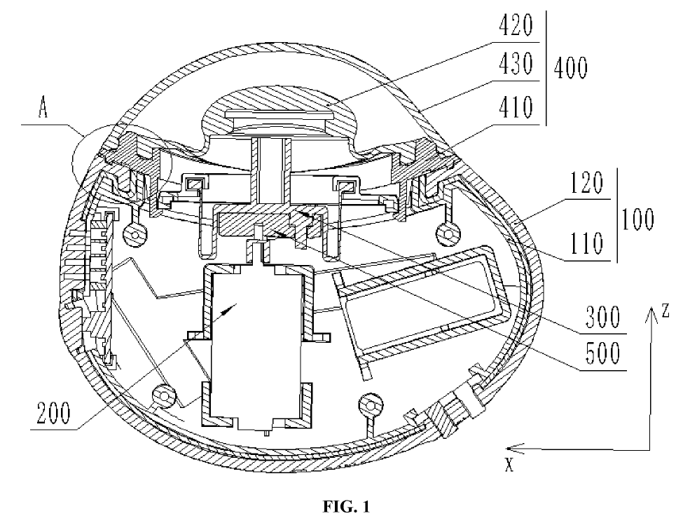

As shown in FIG. 1, the reciprocating massage device provided in the present disclosure includes a machine shell 100, a driving member 200, an elastic frame 300 and a massage head 400; the driving member 200 and the elastic frame 300 are respectively mounted on the machine shell 100, the driving member 200 is in transmission connection with the elastic frame 300, and drives the movable part 301 of the elastic frame 300 to move reciprocally; the massage head 400 is in transmission connection with the movable part 301.

When a part of the human body is subjected to mechanical vibration massage, the skin and muscles are driven to form tremors. If the vibration range is concentrated, it is easy to cause excessive local vibration sensation, thereby causing numbness. In addition, when mechanical vibration is not constrained, as the vibration intensity increases, the vibration direction and vibration amplitude are prone to disorderly changes, which further leads to excessively disordered tremor amplitude and direction of the skin and muscles in the massaged part, thereby further affecting massage comfort. In the present embodiment, the movable part 301 has a degree of freedom to drive the massage head 400 to move reciprocally, thereby forming mechanical vibration massage. The range of motion of the massage head 400 is increased, resulting in a broader effective range of the massage vibration sensation, thus avoiding numbness caused by an excessively concentrated range of the vibration sensation. In addition, the movable part 301 can be constrained by the elastic frame 300, thereby reducing the disorderly changes in the vibration direction and vibration amplitude of the movable part 301, by which excessive tremor of the massage head 400 can be limited, thus alleviating numbness and discomfort in the massaged part.

It is worth adding that the movable part 301 reciprocates under the driving action of the driving member 200. When approaching the limit position of the movement stroke, the elastic force of the elastic frame 300 increases, so that the movable part 301 can move in the reverse direction more smoothly. This reduces the vibration of the machine shell 100 caused by the reciprocating movement of the movable part 301, and reduces the vibration sensation when holding the machine shell 100.

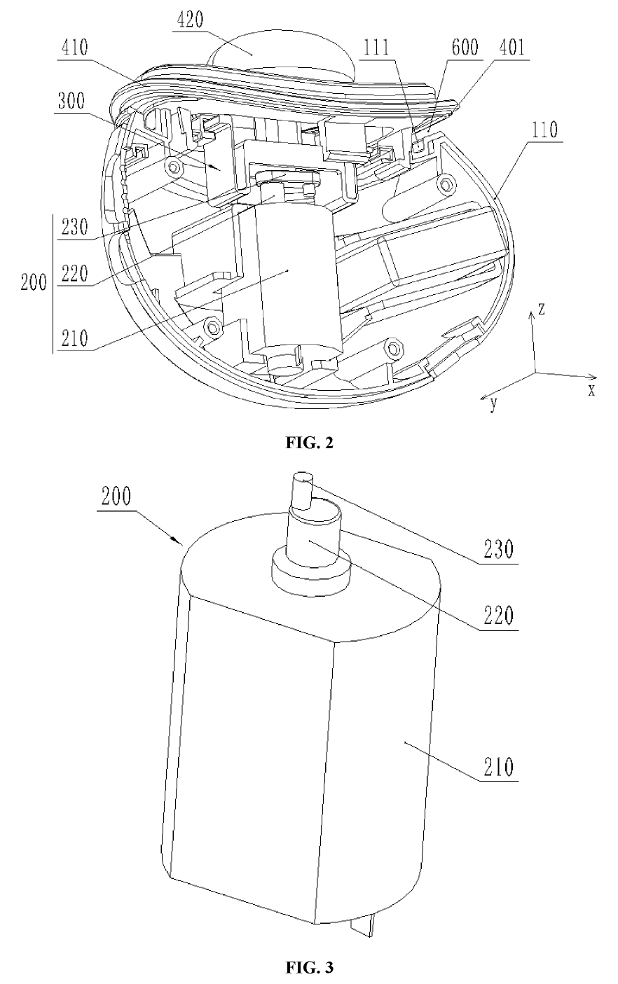

As shown in FIG. 1, FIGS. 2 and FIG. 5, in the embodiment of the present disclosure, the movable part 301 has a degree of freedom to move reciprocally along the x-direction, and the elastic frame 300 and the massage head 400 are arranged along the z-direction, wherein the x-direction is perpendicular to the z-direction.

During massage, the massage head 400 abuts against the skin of the massaged part along the z-direction, and the movable part 301 drives the massage head 400 to realize linear reciprocating movement along the x-direction, so as to avoid the massage head 400 producing a hammering action on the human body along the z-direction during massage. The massage head 400 contacts and drives the massaged part to move linearly back and forth along the skin surface, so as to drive the skin and muscles to produce tremor, thereby achieving the effects of relaxing muscles, promoting blood circulation, and avoiding massage discomfort caused by disordered changes in vibration direction; and the tremor range of the skin and muscles is increased, so as to avoid the excessively small concentrated range of vibration sensation, thereby preventing the massaged part from producing numbness.

It should be noted that the movable part 301 can possess the degree of freedom to move reciprocally along the x-direction through the elastic structure of the elastic frame 300 itself; alternatively, a slide rail or a sliding slot extending along the x-direction can be provided on the machine shell 100, and the movable part 301 is matched with the slide rail or the sliding slot, so that the movable part 301 can move reciprocally along the x-direction.

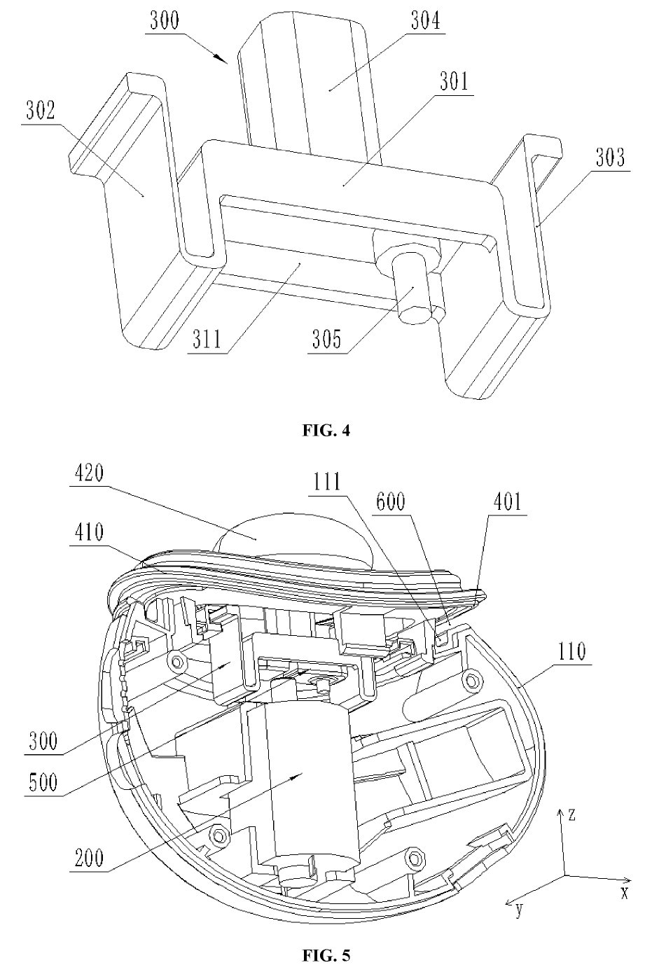

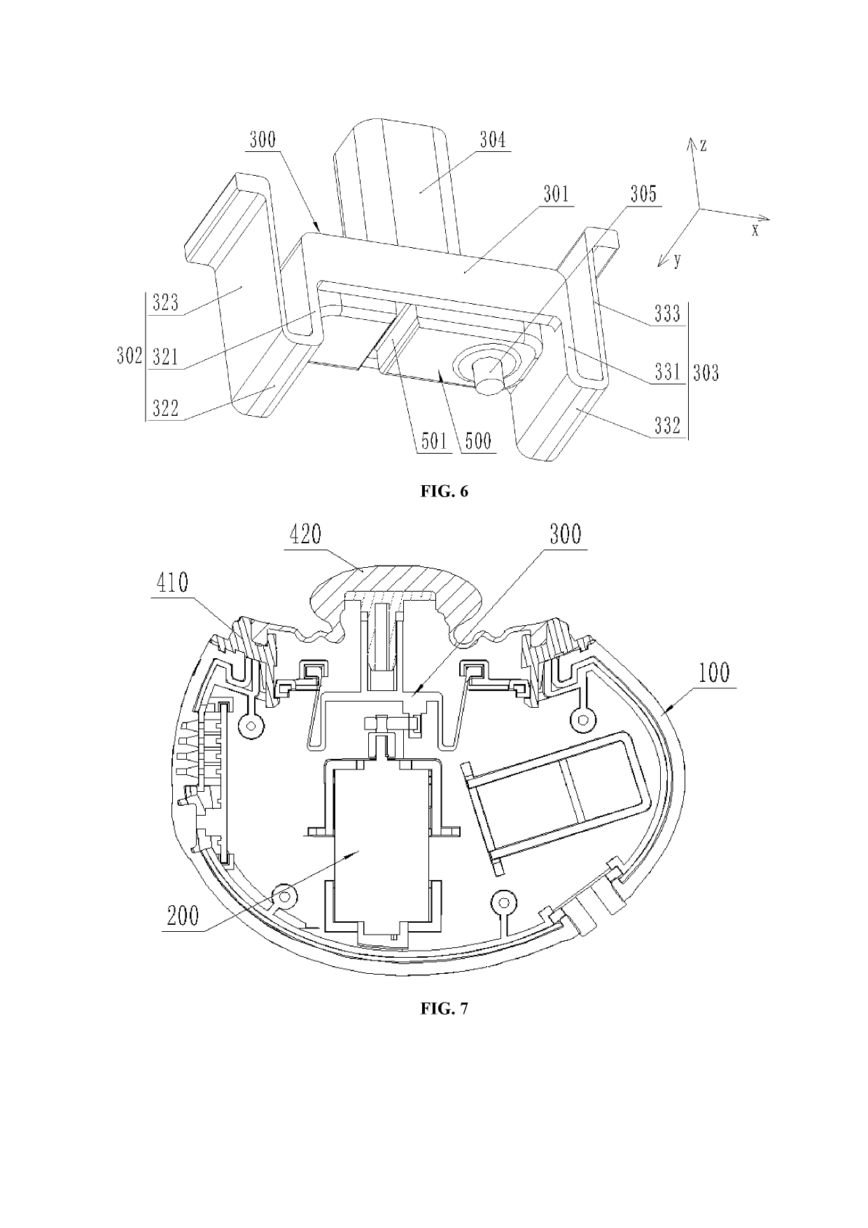

As shown in FIG. 1, FIG. 2, FIG. 4, FIGS. 5 and FIG. 6, one end of the movable part 301 is connected to the first elastic support part 302, and the other end thereof is connected to the second elastic support part 303, wherein the x-direction points from the first elastic support part 302 to the second elastic support part 303; and the first elastic support part 302 and the second elastic support part 303 are respectively connected to the machine shell 100.

In an optional embodiment, both the first elastic support part 302 and the second elastic support part 303 are configured as springs that elastically expand and contract along the x-direction. The movable part 301 is supported by the first elastic support part 302 and the second elastic support part 303 together, so that the movable part 301 can move reciprocally along the x-direction.

In the present embodiment, both the first elastic support part 302 and the second elastic support part 303 are configured as metal elastic pieces. The movable part 301 is supported between the two metal elastic pieces, and the two metal elastic pieces can extend along the z-direction and can elastically swing back and forth along the x-direction, so that the movable part 301 moves reciprocally along the x-direction. In addition, when the movable part 301 moves reciprocally along the x-direction to the stroke limit position, the extension dimension of the two swinging metal elastic pieces in the z-direction is reduced, which can be understood as follows: as the movable part 301 moves toward the end of the stroke, it further contracts slightly along the z-direction; during massage, as the massage head 400 moves reciprocally, the pressing force of the massage head 400 on the skin weakens as the movable part 301 contracts along the z-direction at the stroke limit position, so that the pressure on the skin at the tremor limit position is reduced, thereby reducing massage discomfort and improving massage comfort.

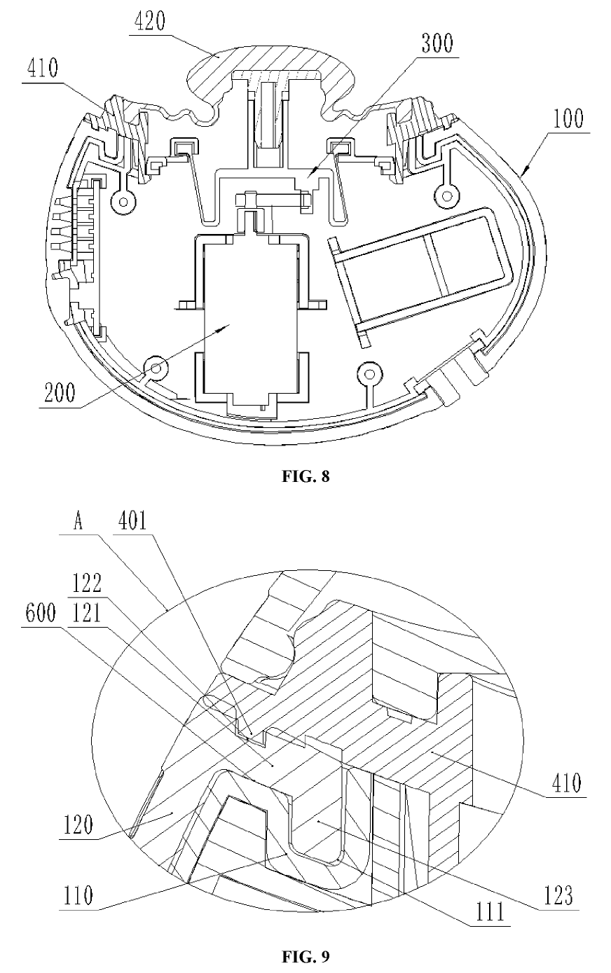

As shown in FIG. 1, FIG. 4, FIG. 5, FIG. 6, FIGS. 7 and FIG. 8, the first elastic support part 302 includes a first longitudinal arm 321, a first bending part 322 and a first spring arm 323. The first longitudinal arm 321 and the first spring arm 323 are spaced apart and respectively extend along the z-direction. The top end of the first longitudinal arm 321 is connected to the movable part 301, and the bottom end of the first longitudinal arm 321 is connected to the bottom end of the first spring arm 323 through the first bending part 322. The second elastic support part 303 includes a second longitudinal arm 331, a second bending part 332 and a second spring arm 333. The second longitudinal arm 331 and the second spring arm 333 are spaced apart and respectively extend along the z-direction. The top end of the second longitudinal arm 331 is connected to the movable part 301, and the bottom end of the second longitudinal arm 331 is connected to the bottom end of the second spring arm 333 through the second bending part 332. The top end of the first spring arm 323 and the top end of the second spring arm 333 are respectively connected to the machine shell 100.

The top ends of the first spring arm 323 and the second spring arm 333 are respectively provided with hook parts, and the first spring arm 323 and the second spring arm 333 are respectively connected to the machine shell 100 through the hook parts. The first longitudinal arm 321 and the first spring arm 323 are spaced apart to form a movable gap, and the second longitudinal arm 331 and the second spring arm 333 are spaced apart to form a movable gap. The first spring arm 323 and the second spring arm 333 are elastically deformed and swing, so as to realize the reciprocating movement of the movable part 301 along the x-direction.

Further, the first elastic support part 302 and the second elastic support part 303 are respectively formed by bending sheet-like structures. The thickness dimension of the first spring arm 323 is smaller than that of the first longitudinal arm 321, and the thickness dimension of the second spring arm 333 is smaller than that of the second longitudinal arm 331. By reducing the thickness dimensions of the first spring arm 323 and the second spring arm 333, the first spring arm 323 and the second spring arm 333 can be more easily bent and deformed, thereby reducing the elastic resistance that needs to be overcome to drive the movement of the movable part 301, making the driving of the movable part 301 by the driving member 200 smoother and the transmission efficiency higher.

In addition, the sheet-like structure mainly undergoes changes in the degree of bending during elastic deformation, and is not easy to produce torsional deformation, which can ensure that the degree of freedom of the movable part 301 is mainly reflected in the reciprocating movement along the x-direction. The direction of the vibration massage effect generated by the massage head 400 driven by the movable part 301 is more orderly, and the massage comfort is higher. It can further avoid the offset of the movable part 301 during the reciprocating movement, thereby preventing the movable part 301 from rubbing or colliding with the inner wall of the machine shell 100 due to deflection, reducing the operating noise of the device and prolonging the service life of the device.

In the present embodiment, the movable part 301, the first elastic support part 302 and the second elastic support part 303 are configured as an integral structure. The movable part 301, the first elastic support part 302 and the second elastic support part 303 can adopt a metal material to form an integral structure by stamping or bending processing, and the structural performance thereof can be improved through heat treatment, resulting in better elasticity and flexibility. Furthermore, it is easy to process and has lower production costs.

As shown in FIG. 1, FIG. 2, FIG. 3, FIGS. 4 and FIG. 5, the driving member 200 includes a motor 210 and an eccentric wheel 220. The eccentric wheel 220 is in transmission connection with the motor 210, an eccentric shaft 221 is connected to the eccentric wheel 220, the axis of the eccentric shaft 221 is spaced and parallel to the axis of the eccentric wheel 220, and the eccentric shaft 221 is in transmission connection with the movable part 301.

The axes of the eccentric wheel 220 and the eccentric shaft 221 both extend along the z-direction. The motor 210 drives the eccentric wheel 220 to rotate around its own axis, thereby driving the eccentric shaft 221 to rotate around the axis of the eccentric wheel 220. The movable part 301 can be in transmission connection through the eccentric shaft 221, so as to drive the movable part 301 to realize periodic movement along the plane perpendicular to the eccentric shaft 221. The stroke range of the movable part 301 is large, which can make the vibration action range of the massage head 400 much larger than that formed by a conventional vibration motor. Therefore, the jitter effect around the massaged part is better and the massage comfort is higher.

In an optional embodiment, the driving member 200 further includes a connecting rod 230, wherein one end of the connecting rod 230 is hinged to the eccentric wheel 220 through the eccentric shaft 221, and the other end of the connecting rod 230 is hinged to the movable part 301.

When the eccentric wheel 220 drives the eccentric shaft 221 to rotate around the axis of the eccentric wheel 220, the eccentric shaft 221 drives the connecting rod 230, and the connecting rod 230 is hinged to the movable part 301 through the shaft part 305 connected to the movable part 301, so that the movable part 301 can be pushed and pulled, and then the movable part 301 is driven to reciprocate along the x-direction.

In addition, in other optional embodiments, the driving member 200 can further adopt an electromagnetic drive mechanism, which uses the magnetic force generated by the electromagnet to realize the reciprocating direction change of the magnetic force, so as to directly drive the magnet to reciprocate, and the movable part 301 can be driven to reciprocate along the x-direction through the magnet.

As shown in FIG. 1, FIG. 3, FIG. 4, FIGS. 5 and FIG. 6, in another optional embodiment, the movable part 301 is connected with a shock-absorbing member 500, and the eccentric wheel 220 is in transmission connection with the shock-absorbing member 500 to drive the movable part 301.

The eccentric wheel 220 can be in direct contact with the shock-absorbing member 500 through the eccentric shaft 221 to realize transmission, or the eccentric wheel 220 can be hinged to one end of a rod member through the eccentric shaft 221, and the other end of the rod member is hinged to the shock-absorbing member 500, and the shock-absorbing member 500 is pushed and pulled through the rod member, thereby driving the movable part 301 to reciprocate. The shock-absorbing member 500 can reduce the mechanical impact transmitted from the driving member 200 to the movable part 301, reduce vibration noise, so as to improve the quietness during the massager operation.

In an optional embodiment, a groove 311 can be provided on the movable part 301, and the shock-absorbing member 500 is inserted into the groove 311.

The movable part 301 is processed to form the groove 311 by means of stamping or cutting, and the shock-absorbing member 500 is embedded in the groove 311, so as to realize the tight connection between the movable part 301 and the shock-absorbing member 500 with a compact structure. In addition, the movable part 301 is connected with a shaft part 305, the shock-absorbing member 500 is provided with a hole matching the shaft part 305, the shock-absorbing member 500 is mounted in the groove 311, the shaft part 305 is inserted into the hole on the shock-absorbing member 500, so that the connection between the shock-absorbing member 500 and the movable part 301 is more stable. Moreover, the shock-absorbing member 500 can further be in interference fit in the groove 311, or the shock-absorbing member 500 can be bonded to the movable part 301 and the shaft part 305, so as to improve the connection stability.

As shown in FIG. 3, FIGS. 5 and FIG. 6, in an optional embodiment, the shock-absorbing member 500 is provided with a sliding slot 501 extending along the y-direction, and the eccentric shaft 221 extends along the z-direction, wherein the x-direction, y-direction and z-direction are perpendicular to each other; the eccentric shaft 221 is in sliding fit with the sliding slot 501.

When the eccentric wheel 220 rotates, the eccentric shaft 221 can slide along the sliding slot 501, thereby driving the shock-absorbing member 500 to reciprocate along the x-direction, and the shock-absorbing member 500 and the movable part 301 can synchronously reciprocate along the x-direction.

It should be noted that the elastic frame 300 is in a natural state, or the elastic forces of the first elastic support part 302 and the second elastic support part 303 counterbalance each other, so that the movable part 301 is at the stroke center position in the x-direction. Under this condition, the plane where the axis of the eccentric shaft 221 and the axis of the eccentric wheel 220 are located is parallel to the yz plane. As the eccentric wheel 220 is driven to rotate, the eccentric shaft 221 drives the movable part 301 to reciprocate along the x-direction. As the movable part 301 moves away from the stroke center position, the elastic resistance on the movable part 301 gradually increases, and the speed in the x-direction gradually decreases, making the direction change during the reciprocating process smoother and the vibration noise smaller.

In addition, since the movable part 301 drives the massage head 400, the massage head 400 contacts the skin and reciprocates along the x-direction. As the movable part 301 gradually decelerates and turns around at both ends of the stroke in the x-direction, the pulling effect of the massage head 400 on the skin at the stroke limit position in the x-direction is weakened, the tremor of the skin and muscles is more soothing, and the massage comfort is higher.

As shown in FIGS. 1 and FIG. 2, the driving member 200 can be powered by a rechargeable battery mounted in the machine shell 100, or can be powered by a detachably mounted dry battery. To avoid the inconvenience of repeatedly replacing batteries, a rechargeable battery is adopted for power supply, coupled with a power level display screen or an indicator light, thereby significantly enhancing the convenience of using the massager.

As shown in FIG. 1, FIGS. 4 and FIG. 6 , the movable part 301 is connected with a support part 304, wherein the support part 304 is inserted into the massage head 400, the movable part 301 can drive the support part 304 to reciprocate along the x-direction, and the massage head 400 is driven by the support part 304 to realize reciprocating vibration massage.

In an optional embodiment, the support part 304 can adopt a hard support body, wherein the hard support body can be supported in the soft massage head 400, thereby preventing the massage head 400 from being excessively deformed due to softness, and further avoiding the weakening of massage strength caused by the excessive softness of the massage head 400. Through such a design, the soft touch of the massage head 400 is retained, and stable and effective massage intensity can further be provided during its working process.

In another optional embodiment, the support part 304 can adopt a soft rubber support body, wherein the soft rubber support body can drive the massage head 400 to reciprocate, and the soft rubber support body can produce elastic deformation, thereby realizing flexible transmission. This not only can mitigate transmission impact, but also can improve massage comfort, making it suitable for users who are sensitive to massage intensity. Moreover, under the condition that the massage head 400 is made of a soft material, the soft massage head 400 is sleeved over the soft rubber support body. The nesting of these two components makes the overall structure softer and enhances the skin’s tactile comfort.

In an optional embodiment, the support part 304 can further be detachably connected to the movable part 301 by means of threaded fit or snap connection, so that support parts 304 with different hardness and elastic coefficients can be replaced.

As shown in FIG. 1, FIG. 2, FIG. 4, FIG. 5, FIGS. 7 and FIG. 8, the massage head 400 includes a soft rubber head 420, wherein the soft rubber head 420 is in transmission connection with the movable part 301, and the soft rubber head 420 contacts the skin to improve massage comfort.

Further, the massage head 400 further includes a mounting frame 410, the soft rubber head 420 is connected to the mounting frame 410, and the mounting frame 410 is detachably connected to the machine shell 100.

A plurality of massage heads 400 with soft rubber heads 420 of different shapes and hardness can be configured, so that the users can replace the massage head 400 according to their own preference during massage.

It should be noted that the joint between the soft rubber head 420 and the mounting frame 410 is in interference fit or sealed and bonded, and then the mounting frame 410 is tightly connected to the machine shell 100, so that the driving member 200 and the elastic frame 300 can be sealed inside together through the machine shell 100 and the massage head 400.

In addition, the massage head 400 can further be made of an integrally formed soft material, such as silica gel, latex, or foam material. These different materials differ in touch and durability, thereby providing different user experiences. A plurality of independent small massage units can further be mounted on the mounting frame 410, and each unit can be made of different soft materials. Such a design can allow users to obtain a richer massage experience.

In an optional embodiment, a guide rail can further be mounted on the machine shell 100, and the massage head 400 is movably matched with the guide rail, so that the massage head 400 can move more smoothly relative to the machine shell 100, which is suitable for obtaining a larger range of vibration massage effects.

In an optional embodiment, the machine shell 100 can adopt a multi-layer composite material shell, and a combination of multiple materials with different hardness or elasticity can be considered to form the outer shell, so as to achieve a better protective effect. For example, a hard protective layer and a soft buffer layer are sequentially wrapped outside the inner shell. In addition, a nano-coating can further be applied to the surface of the machine shell 100, so as to improve wear resistance and corrosion resistance while maintaining a good touch.

As shown in FIG. 1, FIGS. 2 and FIG. 5, the machine shell 100 includes an inner shell 110 and a soft rubber outer shell 120, the driving member 200 and the elastic frame 300 are respectively mounted inside the inner shell 110, and the soft rubber outer shell 120 is sleeved over the outer side of the inner shell 110.

In an optional embodiment, the inner shell 110 includes two half-shells, and the two half-shells can be spliced to form an inner cavity between them. In addition, the two half-shells can be connected by snap-fitting or bonding, or the inner shell 110 can be sleeved with the soft rubber outer shell 120 to tightly wrap the two half-shells, so that the two half-shells are tightly spliced. The inner shell 110 can further be configured as an integrated cavity shell structure and has an opening communicating with the inner cavity. The driving member 200, the elastic frame 300, the battery and other components are mounted in the inner cavity, and the opening is covered by mounting the massage head 400, so as to seal the inner cavity of the inner shell 110.

In an optional embodiment, the soft rubber outer shell 120 can be made of materials such as silica gel, rubber, latex, etc. These materials make the exterior of the machine shell 100 soft and enhance hand comfort during holding and use.

In addition, a cover body 430 can be sleeved over the outside of the soft rubber head 420, and the cover body 430 protects the soft rubber head 420, so as to prevent the soft rubber head 420 from being corroded or bumped due to exposure. The cover body 430 can be matched and connected with the mounting frame 410 or the soft rubber outer shell 120, and the stable installation of the cover body 430 can be ensured through means such as snap connection or interference fit.

As shown in FIG. 1, FIG. 2, FIGS. 5 and FIG. 9, the massage head 400 is connected to the inner shell 110, and a slot 600 is formed between the massage head 400 and the inner shell 110; one of the massage head 400 and the inner shell 110 is provided with a protruding part 401 protruding into the slot 600, and the other is provided with a limiting slot 111 communicating with the slot 600 and recessed away from the slot 600; the soft rubber outer shell 120 is provided with a flange part 121 inserted into the slot 600, and the flange part 121 is provided with a notch 122 matching the protruding part 401 and a limiting protrusion 123 inserted into the limiting slot 111.

When assembling the massager, first, the driving member 200, the elastic frame 300 and other components are respectively mounted inside the inner shell 110; then, the soft rubber outer shell 120 is sleeved over the outside of the inner shell 110, and the limiting protrusion 123 is made to fit into the limiting slot 111 on the inner shell 110; then, the massage head 400 is mounted on the inner shell 110. The mounting frame 410 can be connected to the inner shell 110 through a snap structure in a matching manner, the flange part 121 is pressed between the inner shell 110 and the mounting frame 410, and the protruding part 401 fits into the notch 122, so that the installation position of the flange part 121 is stable and the soft rubber outer shell 120 is prevented from loosening from the inner shell 110. In addition, the flange part 121 is tightly fitted in the slot 600, and a seal can be formed at the connection between the mounting frame 410 and the machine shell 100, which is beneficial to realizing water resistance and dust resistance inside the machine shell 100.

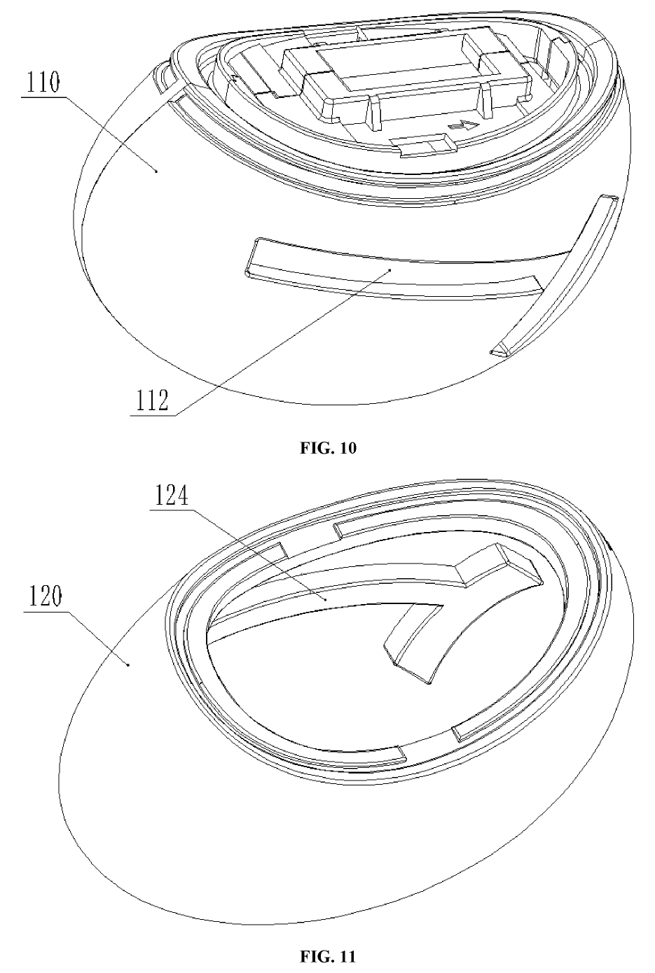

As shown in FIGS. 10 and FIG. 11, in an optional embodiment, an embedded slot 112 can be provided on the outer surface of the inner shell 110, and a soft rubber protrusion 124 matching the embedded slot 112 is provided on the inner side of the soft rubber outer shell 120, which can make the inner shell 110 and the soft rubber outer shell 120 fit more tightly.

Finally, it should be noted that the above embodiments are only used to illustrate the technical solutions of the present disclosure, but not to limit them; although the present disclosure has been described in detail with reference to the foregoing examples, those of ordinary skill in the art should understand that they can still modify the technical solutions recorded in the foregoing examples, or equivalently replace some or all of the technical features; and these modifications or replacements do not make the essence of the corresponding technical solutions deviate from the scope of the technical solutions of the examples of the present disclosure.

1. A reciprocating massage device, comprising: a machine shell, a driving member, an elastic frame and a massage head;
the driving member and the elastic frame are respectively mounted on the machine shell; the driving member is in a transmission connection with the elastic frame, and drives a movable part of the elastic frame to move reciprocally; and
the massage head is in the transmission connection with the movable part.

2. The reciprocating massage device according to claim 1, wherein the movable part has a degree of freedom to move reciprocally along an x-direction; and
the elastic frame and the massage head are arranged along a z-direction, and the x-direction is perpendicular to the z-direction.

3. The reciprocating massage device according to claim 2, wherein one end of the movable part is connected to a first elastic support part, and the other end of the movable part is connected to a second elastic support part; the x-direction points from the first elastic support part to the second elastic support part; and
the first elastic support part and the second elastic support part are respectively connected to the machine shell.

4. The reciprocating massage device according to claim 3, wherein the first elastic support part comprises: a first longitudinal arm, a first bending part and a first spring arm; the first longitudinal arm and the first spring arm are spaced apart and respectively extend along the z-direction; a top end of the first longitudinal arm is connected to the movable part, and a bottom end of the first longitudinal arm is connected to a bottom end of the first spring arm through the first bending part;
the second elastic support part comprises: a second longitudinal arm, a second bending part and a second spring arm; the second longitudinal arm and the second spring arm are spaced apart and respectively extend along the z-direction; a top end of the second longitudinal arm is connected to the movable part, and a bottom end of the second longitudinal arm is connected to a bottom end of the second spring arm through the second bending part; and
a top end of the first spring arm and a top end of the second spring arm are respectively connected to the machine shell.

5. The reciprocating massage device according to claim 4, wherein the first elastic support part and the second elastic support part are respectively formed by a bending sheet-like structure; and
a thickness dimension of the first spring arm is smaller than a thickness dimension of the first longitudinal arm, and a thickness dimension of the second spring arm is smaller than a thickness dimension of the second longitudinal arm.

6. The reciprocating massage device according to claims claim 3, wherein the movable part, the first elastic support part and the second elastic support part are configured as an integrated structure.

7. The reciprocating massage device according to claim 1, wherein the driving member comprises: a motor and an eccentric wheel;
the eccentric wheel is in the transmission connection with the motor, an eccentric shaft is connected to the eccentric wheel, and an axis of the eccentric shaft is spaced apart from and parallel to an axis of the eccentric wheel; and
the eccentric shaft is in the transmission connection with the movable part.

8. The reciprocating massage device according to claim 7, wherein the driving member further comprises a connecting rod; one end of the connecting rod is hinged to the eccentric wheel through the eccentric shaft, and the other end of the connecting rod is hinged to the movable part.

9. The reciprocating massage device according to claim 7, wherein the movable part is connected with a shock-absorbing member, and the eccentric wheel is in the transmission connection with the shock-absorbing member to drive the movable part.

10. The reciprocating massage device according to claim 9, wherein the movable part is provided with a groove, and the shock-absorbing member is inserted into the groove.

11. The reciprocating massage device according to claim 9, wherein the shock-absorbing member is provided with a sliding slot extending along a y-direction, the eccentric shaft extends along the z-direction, and the y-direction is perpendicular to the z-direction; and
the eccentric shaft is slidably fitted in the sliding slot.

12. The reciprocating massage device according to claim 1, wherein the movable part is connected with a support part, and the support part is inserted into the massage head.

13. The reciprocating massage device according to claim 1, wherein the massage head comprises a soft rubber head, and the soft rubber head is in the transmission connection with the movable part.

14. The reciprocating massage device according to claim 13, wherein the massage head further comprises a mounting frame, the soft rubber head is connected with the mounting frame, and the mounting frame is detachably connected with the machine shell.

15. The reciprocating massage device according to claim 1, wherein the machine shell comprises: an inner shell and a soft rubber outer shell; and
the driving member and the elastic frame are respectively mounted inside the inner shell, and the soft rubber outer shell is sleeved over an outer side of the inner shell.

16. The reciprocating massage device according to claim 15, wherein the massage head is connected with the inner shell, and a slot is formed between the massage head and the inner shell;
one of the massage head and the inner shell is provided with a protruding part protruding into the slot, and the other is provided with a limiting slot communicating with the slot and recessed away from the slot; and
the soft rubber outer shell is provided with a flange part inserted into the slot, and the flange part is provided with a notch matching the protruding part and a limiting protrusion inserted into the limiting slot.

17. The reciprocating massage device according to claims claim 4, wherein the movable part, the first elastic support part and the second elastic support part are configured as an integrated structure.

18. The reciprocating massage device according to claims claim 5, wherein the movable part, the first elastic support part and the second elastic support part are configured as an integrated structure.
